(19) United States
(12) Patent Application Publication
(10) Pub. No.: US 2012/0123619 A1
(43) Pub. Date: May 17, 2012

(54) APPARATUS AND METHOD FOR PROLONGING BATTERY LIFE OF PLUG-IN HYBRID VEHICLE

(75) Inventors: Pin Yung Chen, Hsinchu City (TW); E In Wu, Chiayi City (TW); Chien Hsun Wu, Taipei County (TW)

(73) Assignee: INDUSTRIAL TECHNOLOGY RESEARCH INSTITUTE, Hsinchu (TW)

(21) Appl. No.: 13/010,730

(22) Filed: Jan. 20, 2011

(30) Foreign Application Priority Data
Nov. 17, 2010 (TW) 099139612

(51) Int. Cl. B60W 20/00; B60W 10/08; B60W 10/06

(52) U.S. Cl. 701/22; 180/65.265; 903/930; 180/65.245

(57) ABSTRACT

An apparatus for prolonging battery life of a plug-in hybrid vehicle includes an engine generator set, a motor, a storage battery, a first automatic switch apparatus, a second automatic switch apparatus and a system control unit. The motor, the engine generator set and the storage battery are electrically connected to one another. The first automatic switch apparatus is coupled between the motor and the storage battery, so as to conduct or cut off the electrical connection between the two. The second automatic switch apparatus is coupled between the engine generator set and the storage battery, so as to conduct or cut off the electrical connection between the two. The system control unit is electrically connected to the above components, and judges a residual electric quantity of the storage battery and an efficiency value of the engine generator set, so as to control the first or the second automatic switch apparatus.

### CROSS-REFERENCE TO RELATED APPLICATIONS

This non-provisional application claims priority under 35 U.S.C. §119(a) on Patent Application No(s). 099139612 filed in Taiwan, R.O.C. on Nov. 17, 2010, the entire contents of which are hereby incorporated by reference.

### BACKGROUND

1. Field

The present disclosure relates to an apparatus and a method for prolonging a vehicle battery life, and more particularly to an apparatus and a method for prolonging a battery life of a plug-in hybrid vehicle.

2. Related Art

The known power sources used by vehicles at present include an internal combustion engine (diesel, petroleum, or alternative fuel), a solar power system, and an electric drive system (a fuel battery, or a lithium battery). Among the above power sources, some have good effect and durability, but fail to conform to the environmental protection requirements; while some conform to the environmental protection requirements, but fail to meet the vehicle travel requirements.

An electric car and a solar car are taken as examples. They do not use the internal combustion engine, so as to conform to the environmental protection requirements. However, actually, the energy density of the electric car and the solar car is relatively low, and the power density also fails to meet the driving requirements. Therefore, it is infeasible to entirely use the electric car and the solar car to replace the conventional internal combustion engine car at present. After countless times of research by vehicle manufacturers, a hybrid vehicle using two power sources has attracted increasing attention. The hybrid vehicle using hybrid power sources not only has good power effect and durability, but also conforms to the environmental protection requirements.

For example, since the biggest problem of the pure electric vehicle lies in endurance, that is, the mileage the pure electric vehicle can travel after each charging is limited, a conventional range-extended/extended range electric vehicle is developed, which is capable of charging the battery in the case of power shortage of the car battery by improving the architecture of the pure electric vehicle. Therefore, the range-extended/extended range electric vehicle solves the problem of limited endurance of the pure electric vehicle, and thus has high development potential.

As for the technologies of charging the electric vehicle battery, many conventional methods exist. For example, in U.S. Pat. No. 5,495,907, an engine generator is connected to a battery assembly, and when the battery assembly needs charging, the engine generator charges the battery. For another example, in U.S. Pat. No. 5,588,498, a charged condition detector is connected to a battery, and the charge condition detector detects the electric quantity of the battery, and controls an engine to drive a generator to charge the battery when the electric quantity is insufficient.

However, as the battery is repeatedly exhausted and charged to saturation over a long period of time, the service life of the battery is greatly reduced. Moreover, in the prior art, no desirable battery protection measures to this problem are proposed, so the battery of the range-extended/extended range electric vehicle needs to be frequently replaced due to this problem, and as a result, the material consumption cost of the range-extended/extended range electric vehicle is increased, which is not favored by consumers.

### SUMMARY

Accordingly, the present disclosure is an apparatus and a method for prolonging a battery life of a plug-in hybrid vehicle, so as to solve the problem in the prior art that the battery life is reduced as the battery is repeatedly exhausted and charged to saturation over a long period of time.

The present disclosure provides an apparatus for prolonging a battery life of a plug-in hybrid vehicle, which comprises an engine generator set, a motor, a storage battery, a first automatic switch apparatus, a second automatic switch apparatus and a system control unit. The motor is electrically connected to the engine generator set, and the engine generator set is capable of supplying electric energy to the motor. The storage battery is electrically connected to the motor and the engine generator set respectively. The first automatic switch apparatus is coupled between the motor and the storage battery, and is driven to conduct or cut off the electrical connection between the storage battery and the motor. The second automatic switch apparatus is coupled between the engine generator set and the storage battery, and is driven to conduct or cut off the electrical connection between the engine generator set and the storage battery. The system control unit is electrically connected to the engine generator set, the motor, the first automatic switch apparatus and the second automatic switch apparatus. The system control unit judges a residual electric quantity of the storage battery and an efficiency value of the engine generator set, and drives the first automatic switch apparatus or the second automatic switch apparatus according to the residual electric quantity and the efficiency value.

The present disclosure provides a method for prolonging a battery life of a plug-in hybrid vehicle, which comprises the following steps. The apparatus for prolonging the battery life of the plug-in hybrid vehicle as described above is provided. Then, the system control unit drives the second automatic switch apparatus to cut off the electrical connection between the storage battery and the engine generator set, and the system control unit drives the first automatic switch apparatus to conduct the electrical connection between the storage battery and the motor, so that the storage battery supplies electric energy to the motor. Then, the system control unit judges whether the residual electric quantity of the storage battery is smaller than a preset value. If the residual electric quantity of the storage battery is larger than or equal to the preset value, the system control unit enables the apparatus for prolonging the battery life of the plug-in hybrid vehicle to maintain the present state. If the residual electric quantity of the storage battery is smaller than the preset value, the system control unit judges whether the efficiency value of the engine generator set is larger than a predetermined efficiency value. If the efficiency value of the engine generator set is smaller than or equal to the predetermined efficiency value, the system control unit drives the first automatic switch apparatus to cut off the electrical connection between the storage battery and the motor, the system control unit drives the second automatic switch apparatus to conduct the electrical connection between the storage battery and the engine generator set, and the system control unit controls the engine generator set to supply electric energy to the motor.

According to the apparatus and the method for prolonging the battery life of the plug-in hybrid vehicle, the first automatic switch apparatus is coupled between the motor and the storage battery, and the second automatic switch apparatus is coupled between the engine generator set and the storage battery, so as to adjust the electrical connection there-between. The system control unit detects the residual electric quantity of the storage battery and the efficiency value of the engine generator set, so as to control the first automatic switch apparatus or the second automatic switch apparatus. In this way, the random charge of the battery is avoided, thus prolonging the battery life, and the engine generator set is enabled to maintain an optimum efficiency state, thus improving the efficiency of the whole system.

These and other aspects of the present disclosure will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the disclosure and, together with the written description, serve to explain the principles of the disclosure. Wherever possible, the same reference numbers are used throughout the drawings to refer to the same or like elements of an embodiment, and wherein:

FIG. 1 is a schematic structural view of an apparatus for prolonging a battery life of a plug-in hybrid vehicle according to an embodiment of the present disclosure;

FIG. 2A is a view of a power supply state of an apparatus for prolonging a battery life of a plug-in hybrid vehicle according to an embodiment of the present disclosure;

FIG. 2B is a view of a power supply state of an apparatus for prolonging a battery life of a plug-in hybrid vehicle according to another embodiment of the present disclosure;

FIG. 2C is a view of a power supply state of an apparatus for prolonging a battery life of a plug-in hybrid vehicle according to still another embodiment of the present disclosure;

FIG. 3 is a flow chart of a method for prolonging a battery life of a plug-in hybrid vehicle according to an embodiment of the present disclosure;

FIG. 4A is a schematic structural view of an apparatus for prolonging a battery life of a plug-in hybrid vehicle according to another embodiment of the present disclosure;

FIG. 4B is a structural view of a circuit of a wide-range power supply regulator; and

FIG. 5 is a schematic structural view of an apparatus for prolonging a battery life of a plug-in hybrid vehicle according to still another embodiment of the present disclosure.

### DETAILED DESCRIPTION

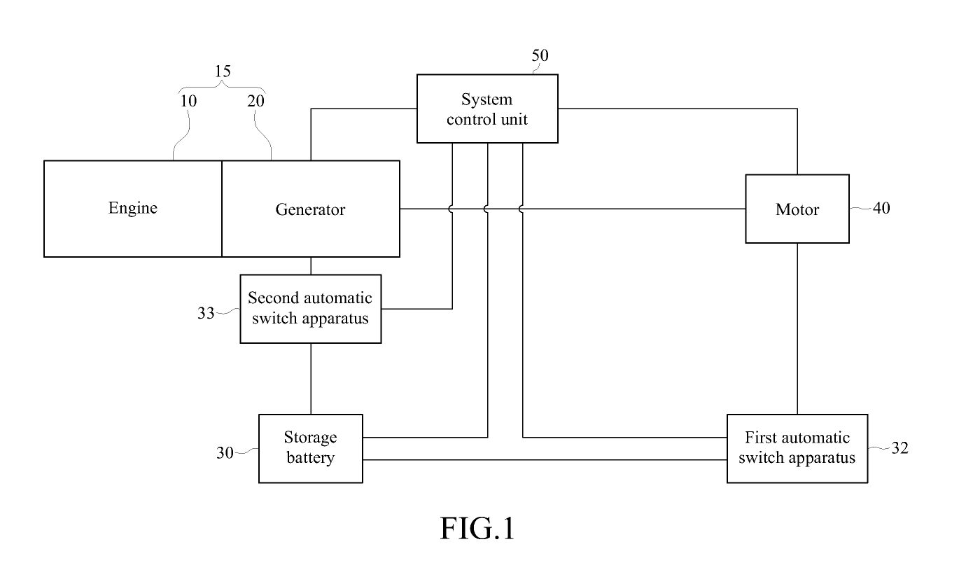

Referring to FIG. 1, FIG. 1 is a schematic structural view of an apparatus for prolonging a battery life of a plug-in hybrid vehicle according to an embodiment of the present disclosure.

An apparatus for prolonging a battery life of a plug-in hybrid vehicle according to an embodiment of the present disclosure comprises an engine generator set 15, a motor 40, a storage battery 30, a first automatic switch apparatus 32, a second automatic switch apparatus 33 and a system control unit 50. The engine generator set 15 comprises an engine 10 and a generator 20, in which the engine 10 is connected to or engaged with the generator 20, and is capable of supplying electric energy to drive the generator 20 to generate electricity. In this embodiment, the engine 10 can directly drive the generator to generate electricity, thus improving the electricity-generating efficiency of the engine generator set 15. In addition, the storage battery 30 of this embodiment may also be replaced by other apparatuses capable of supplying and storing electric energy. The storage battery 30 has a State Of Charge (SOC), which is a percentage obtained by dividing a residual electric quantity of the storage battery 30 by a full electric quantity of the storage battery 30.

The motor 40 is electrically connected to the generator 20 of the engine generator set 15, and the system control unit 50 controls the engine generator set 15 whether to supply electric energy to the motor 40. The storage battery 30 is electrically connected to the motor 40 and the generator 20 of the engine generator set 15 respectively, and the storage battery 30 is capable of storing the electric energy supplied by the engine generator set 15. Moreover, the storage battery 30 may also supply electric energy to the motor 40. That is to say, the motor 40 may receive the electric energy supplied by the engine generator set 15 or the storage battery 30 for operation. The engine generator set 15 has an efficiency value, which is a ratio obtained by dividing an actual output power of the engine generator set 15 by an input power of the engine generator set 15. When the engine generator set 15 has an optimum efficiency value, the whole system is enabled to be in a high efficiency state.

The first automatic switch apparatus 32 is coupled between the motor 40 and the storage battery 30, and is driven to conduct or cut off the electrical connection between the storage battery 30 and the motor 40. When the first automatic switch apparatus 32 conducts the electrical connection between the storage battery 30 and the motor 40, the storage battery 30 outputs the electric energy to the motor 40. The first automatic switch apparatus 32 may also be any other apparatus capable of high power switching, such as a high power relay or related firmware of a program executed by a computer.

The second automatic switch apparatus 33 is coupled between the engine generator set 15 and the storage battery 30, and is driven to conduct or cut off the electrical connection between the engine generator set 15 and the storage battery 30. When the second automatic switch apparatus 33 conducts the electrical connection between the engine generator set 15 and the storage battery 30, the engine generator set 15 outputs the electric energy to the storage battery 30, so as to charge the storage battery 30. The second automatic switch apparatus 33 may also be any other apparatus capable of high power switching, such as a high power relay or related firmware of a program executed by a computer.

The system control unit 50 is electrically connected to the engine generator set 15, the motor 40, the first automatic switch apparatus 32 and the second automatic switch apparatus 33 respectively. The system control unit 50 may detect and judge the SOC of the storage battery 30 and the efficiency value of the engine generator set 15. The system control unit 50 properly controls to drive the first automatic switch apparatus 32 to conduct or cut off the electrical connection between the storage battery 30 and the motor 40, and controls to drive the second automatic switch apparatus 33 to conduct or cut off the electrical connection between the engine generator set 15 and the storage battery 30 according to the SOC of the storage battery 30 and the efficiency value of the engine generator set 15. By driving the first automatic switch apparatus 32 and the second automatic switch apparatus 33 by the system control unit 50 according to the SOC of the storage battery 30 and the efficiency value of the engine generator set 15, the system is maintained in a high efficiency state and the battery life is prolonged. A control method of the apparatus for prolonging the battery life of the plug-in hybrid vehicle is described below.

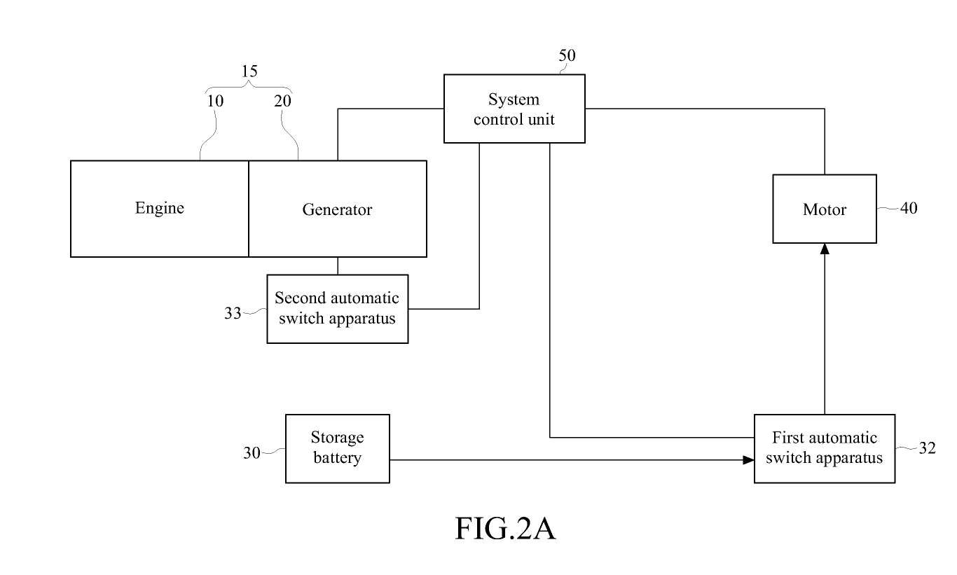

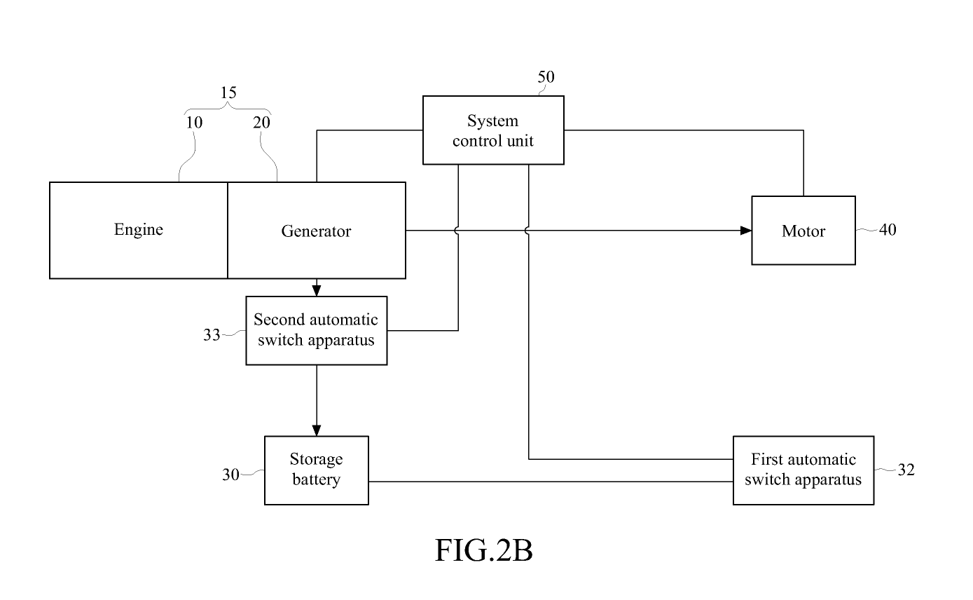

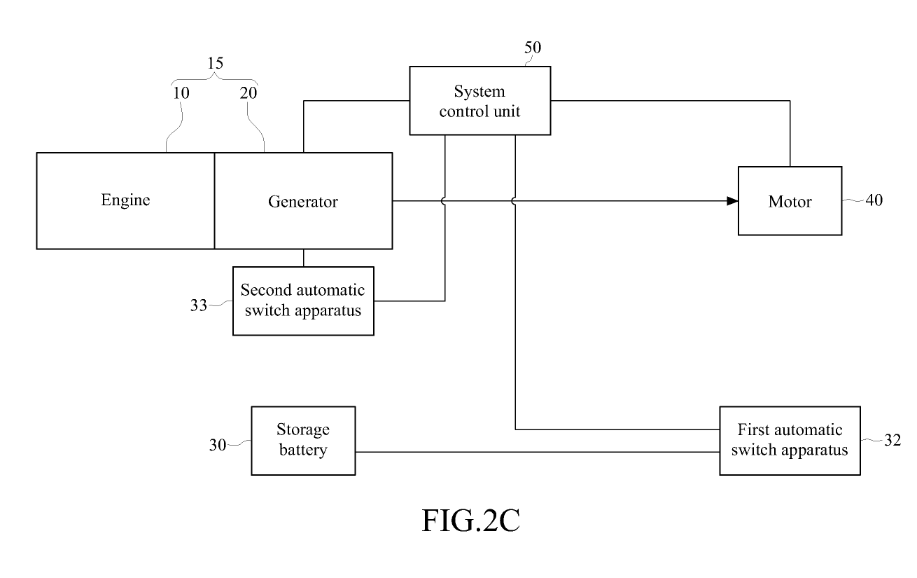

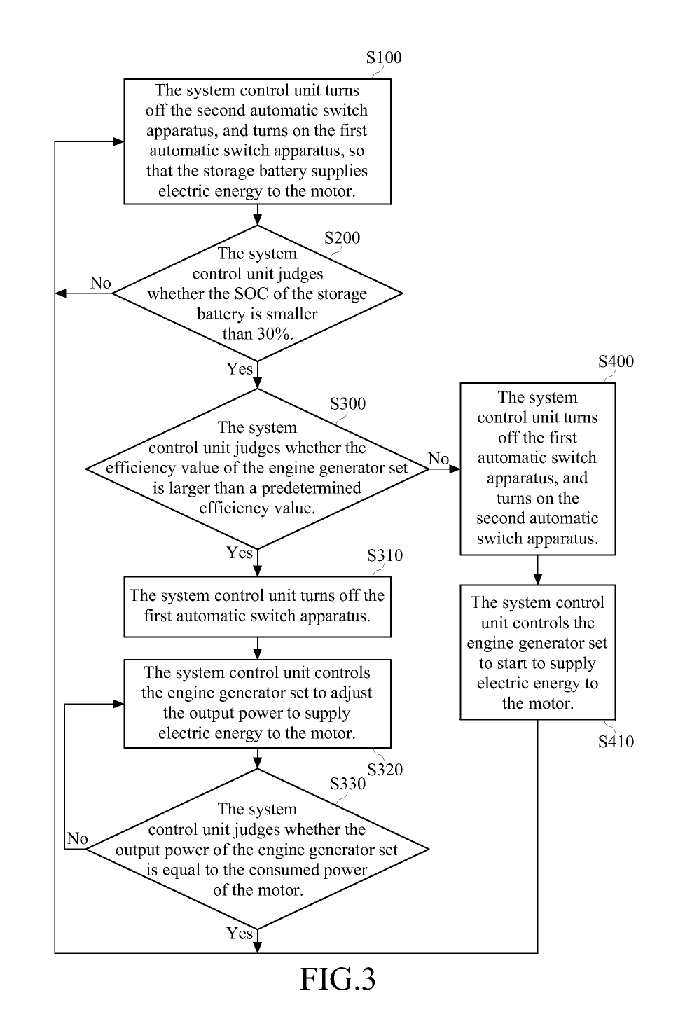

Referring to FIGS. 2A, 2B, 2C and 3, FIG. 2A is a view of a power supply state of an apparatus for prolonging a battery life of a plug-in hybrid vehicle according to an embodiment of the present disclosure, FIG. 2B is a view of a power supply state of an apparatus for prolonging a battery life of a plug-in hybrid vehicle according to another embodiment of the present disclosure, FIG. 2C is a view of a power supply state of an apparatus for prolonging a battery life of a plug-in hybrid vehicle according to still another embodiment of the present disclosure, and FIG. 3 is a flow chart of a method for prolonging a battery life of a plug-in hybrid vehicle according to an embodiment of the present disclosure.

First, the system is made to be in a system initial state, that is, the system control unit 50 turns off the second automatic switch apparatus 33, so as to cut off the electrical connection between the storage battery 30 and the engine generator set 15. The system control unit 50 turns on the first automatic switch apparatus 32, so as to conduct the electrical connection between the storage battery 30 and the motor 40. In this way, the storage battery 30 supplies electric energy to the motor 40 (S100), as shown in FIG. 2A. Then, the system control unit 50 starts a battery residual electric quantity judging mechanism, that is, the system control unit 50 judges whether the SOC of the storage battery 30 is smaller than a preset value, for example, 30% (S200). If the system control unit 50 judges that the SOC of the storage battery 30 is larger than or equal to the preset value (for example, 30%), the system control unit 50 drives the system to maintain the system initial condition and to perform subsequent system operations.

If the system control unit 50 judges that the SOC of the storage battery 30 is smaller than the preset value (for example, 30%), the system control unit 50 starts a mechanism for judging an optimum efficiency of the engine generator set. That is, the system control unit 50 then judges whether the efficiency value of the engine generator set 15 is larger than a predetermined efficiency value (the predetermined efficiency value refers to the optimum efficiency value) (S300).

If the system control unit 50 judges that the efficiency value of the engine generator set 15 is smaller than or equal to the predetermined efficiency value (the optimum efficiency value), the system control unit 50 turns off the first automatic switch apparatus 32, so as to cut off the electrical connection between the storage battery 30 and the motor 40. That is, the storage battery 30 does not supply electric energy to the motor 40. Moreover, the system control unit 50 turns on the second automatic switch apparatus 33, so as to conduct the electrical connection between the storage battery 30 and the engine generator set 15. That is, the engine generator set 15 starts to charge the storage battery (S400). At the same time, the system control unit 50 controls the engine generator set 15 to start to supply electric energy to the motor 40 (S410), as shown in FIG. 2B. In this way, the engine generator set 15 supplies electric energy to the motor 40 and charges the storage battery 30 at the same time, so that the efficiency value of the engine generator set 15 is improved.

If the efficiency value of the engine generator set 15 is larger than the predetermined efficiency value (the optimum efficiency value), the system control unit 50 turns off the first automatic switch apparatus 32, so as to cut off the electrical connection between the storage battery 30 and the motor 40 (S310), and the system control unit 50 controls the engine generator set 15 to adjust the output power to supply electric energy to the motor 40 (S320), as shown in FIG. 2C.

Then, the system control unit 50 starts a power consumption judging mechanism, that is, the system control unit 50 judges whether the output power of the engine generator set 15 is equal to the consumed power of the motor 40 (S330). If the output power of the engine generator set 15 is not equal to the consumed power of the motor 40, the process returns to the step S320. The system control unit 50 controls the engine generator set 15 to adjust the output power until the output power of the engine generator set 15 is equal to the consumed power of the motor 40.

Through the above steps, the SOC of the storage battery 30 is compared with a certain preset value (30%), which is used as an identification of performing charge or discharge. In this way, the effect on the service life of the storage battery 30 due to random charge of the storage battery 30 in the prior art is prevented. Moreover, by adopting corresponding means after the system control unit 50 judges the optimum efficiency value of the engine generator set 15, it can be ensured that the engine generator set 15 maintains a high efficiency state, thus improving the system efficiency.

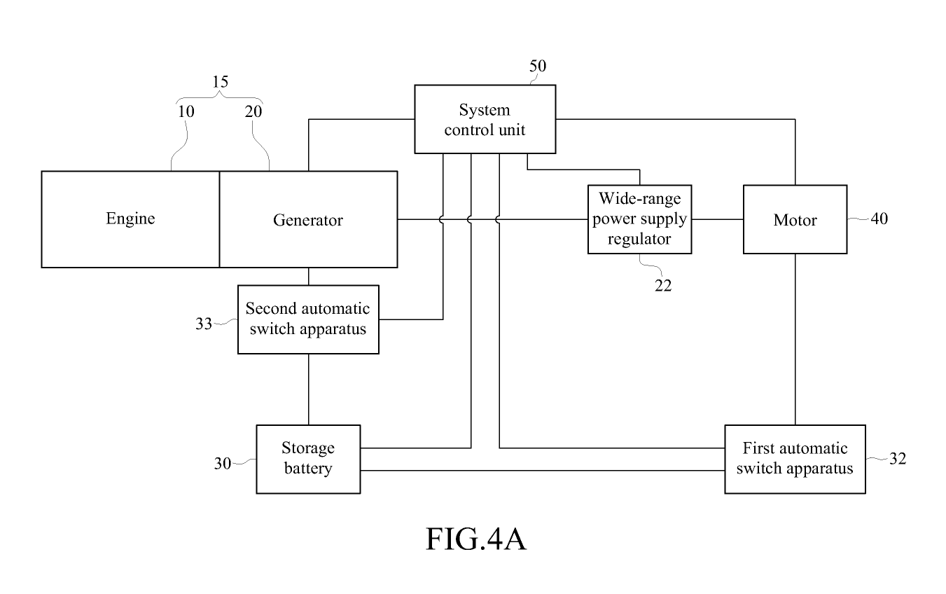

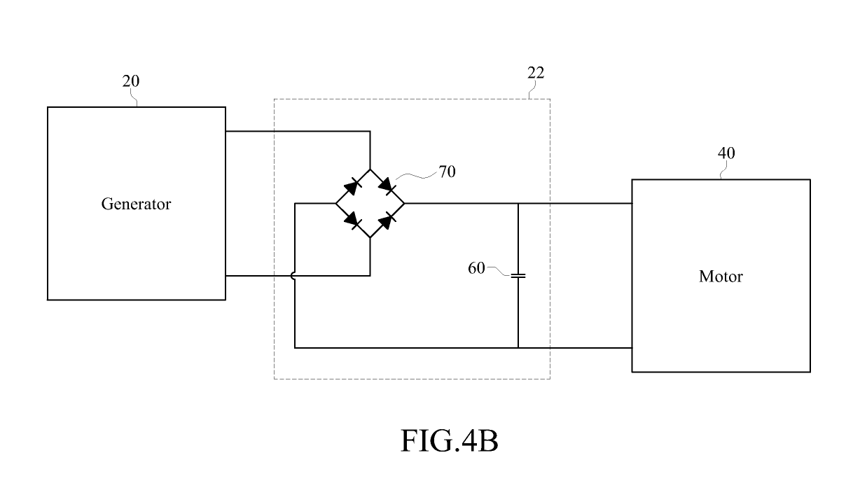

Referring to FIGS. 4A and 4B, FIG. 4A is a schematic structural view of an apparatus for prolonging a battery life of a plug-in hybrid vehicle according to another embodiment of the present disclosure, and FIG. 4B is a structural view of a circuit of a wide-range power supply regulator. Since the structure of this embodiment is the same as the structure of the embodiment in FIG. 1, only the difference there-between is described herein.

In this embodiment, the apparatus for prolonging the battery life of the plug-in hybrid vehicle further comprises a wide-range power supply regulator 22. The wide-range power supply regulator 22 is coupled between the engine generator set 15 and the motor 40 and comprises a bridge rectifier 70 and a capacitor 60, with a circuit diagram as shown in FIG. 4B.

Since a voltage of the electric energy output by the engine generator set 15 is unstable, if the voltage is directly input to the motor 40, the operation effect of the motor 40 is not desirable (for example, the rotation rate changes). Therefore, in this embodiment, through the configuration of the wide-range power supply regulator 22, the output voltage of the engine generator set 15 is rectified and regulated into a stable voltage output. In this way, it can be ensured that the voltage of the electric energy input to the motor 40 is stable, thus ensuring good operation quality of the motor 40.

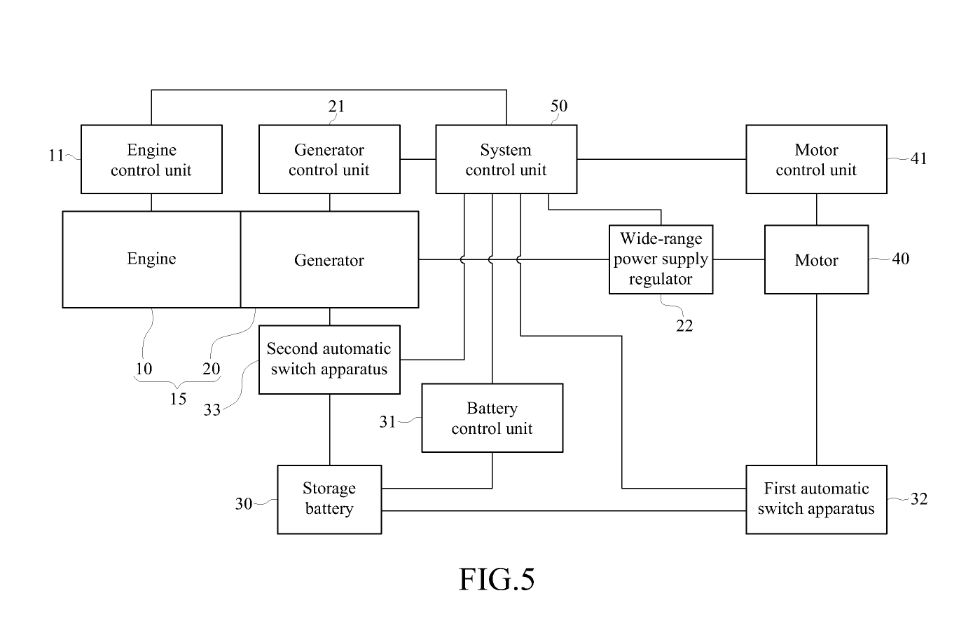

Referring to FIG. 5, FIG. 5 is a schematic structural view of an apparatus for prolonging a battery life of a plug-in hybrid vehicle according to still another embodiment of the present disclosure. Since the structure of this embodiment is the same as the structure of the embodiment in FIG. 4A, only the difference there-between is described herein.

In this embodiment, the apparatus for prolonging the battery life of the plug-in hybrid vehicle further comprises an engine control unit 11, a generator control unit 21, a battery control unit 31 and a motor control unit 41. The engine control unit 11 is coupled between the engine 10 and the system control unit 50. The generator control unit 21 is coupled between the generator 20 and the system control unit 50. The battery control unit 31 is coupled between the storage battery 30 and the system control unit 50. The motor control unit 41 is coupled between the motor 40 and the system control unit 50.

In the embodiment of FIG. 4, the system control unit 50 needs to judge, process, adjust and control the state and operation of all the components, so the system control unit 50 needs to have a high-performance processing chip, and thus the cost of the whole system apparatus is increased. Therefore, in this embodiment, through the configuration of the engine control unit 11, the generator control unit 21, the battery control unit 31 and the motor control unit 41, the processing load of the system control unit 50 can be shared. Thus, the grade of the chip used can be lowered, so as to save the cost of the whole system apparatus.

According to the apparatus and the method for prolonging the battery life of the plug-in hybrid vehicle, the first automatic switch apparatus is coupled between the motor and the storage battery, and the second automatic switch apparatus is coupled between the engine generator set and the storage battery, so as to adjust the electrical connection there-between. The system control unit detects the residual electric quantity of the storage battery and the efficiency value of the engine generator set, so as to control turning on or off of the first automatic switch apparatus and the second automatic switch apparatus, and the control method of this embodiment is used in combination. In this way, the effect on the service life of the storage battery due to random charge of the storage battery in the prior art is prevented. Moreover, by adopting corresponding means after the system control unit judges the optimum efficiency value of the engine generator set, it can be ensured that the engine generator set maintains a high efficiency state, thus improving the whole system efficiency.

What is claimed is:

1. An apparatus for prolonging a battery life of a plug-in hybrid vehicle, comprising:
an engine generator set;
a motor, electrically connected to the engine generator set, wherein the engine generator set is capable of supplying electric energy to the motor;
a storage battery, electrically connected to the motor and the engine generator set respectively;
a first automatic switch apparatus, coupled between the motor and the storage battery, wherein the first automatic switch apparatus is driven to conduct or cut off the electrical connection between the storage battery and the motor;
a second automatic switch apparatus, coupled between the engine generator set and the storage battery, wherein the second automatic switch apparatus is driven to conduct or cut off the electrical connection between the engine generator set and the storage battery; and
a system control unit, electrically connected to the engine generator set, the motor, the first automatic switch apparatus and the second automatic switch apparatus, wherein the system control unit judges a residual electric quantity of the storage battery and an efficiency value of the engine generator set, and drives the first automatic switch apparatus and the second automatic switch apparatus according to the residual electric quantity and the efficiency value.

2. The apparatus for prolonging the battery life of the plug-in hybrid vehicle according to claim 1, wherein the system control unit judges an output power of the engine generator set and a consumed power of the motor, and adjusts the output power of the engine generator set according to the output power and the consumed power.

3. The apparatus for prolonging the battery life of the plug-in hybrid vehicle according to claim 1, further comprising a wide-range power supply regulator, coupled between the engine generator set and the motor, so as to stabilize a voltage output from the engine generator set to the motor.

4. The apparatus for prolonging the battery life of the plug-in hybrid vehicle according to claim 1, wherein the engine generator set comprises an engine and a generator, the engine is connected to or engaged with the generator, and the generator is electrically connected to the motor and the storage battery.

5. The apparatus for prolonging the battery life of the plug-in hybrid vehicle according to claim 4, further comprising a generator control unit and an engine control unit, wherein the generator control unit is coupled between the generator and the system control unit, and the engine control unit is coupled between the engine and the system control unit.

6. The apparatus for prolonging the battery life of the plug-in hybrid vehicle according to claim 1, further comprising a motor control unit, coupled between the motor and the system control unit.

7. The apparatus for prolonging the battery life of the plug-in hybrid vehicle according to claim 1, further comprising a battery control unit, coupled between the storage battery and the system control unit.

8. A method for prolonging a battery life of a plug-in hybrid vehicle, comprising:
providing the apparatus for prolonging the battery life of the plug-in hybrid vehicle according to claim 1;
driving the second automatic switch apparatus by the system control unit to cut off the electrical connection between the storage battery and the engine generator set, and driving the first automatic switch apparatus by the system control unit to conduct the electrical connection between the storage battery and the motor, so that the storage battery supplies electric energy to the motor;
judging whether the residual electric quantity of the storage battery is smaller than a preset value by the system control unit;
enabling the apparatus for prolonging the battery life of the plug-in hybrid vehicle to maintain the present state by the system control unit if the residual electric quantity of the storage battery is larger than or equal to the preset value;
judging whether the efficiency value of the engine generator set is larger than a predetermined efficiency value by the system control unit if the residual electric quantity of the storage battery is smaller than the preset value; and
driving the first automatic switch apparatus by the system control unit to cut off the electrical connection between the storage battery and the motor, driving the second automatic switch apparatus by the system control unit to conduct the electrical connection between the storage battery and the engine generator set, so that the engine generator set charges the storage battery, and controlling the engine generator set to supply electric energy to the motor by the system control unit, if the efficiency value of the engine generator set is smaller than or equal to the predetermined efficiency value.

9. The method for prolonging the battery life of the plug-in hybrid vehicle according to claim 8, further comprising:
driving the first automatic switch apparatus by the system control unit to cut off the electrical connection between the storage battery and the motor, and controlling the engine generator set to supply electric energy to the motor by the system control unit if the efficiency value of the engine generator set is larger than the predetermined efficiency value.

10. The method for prolonging the battery life of the plug-in hybrid vehicle according to claim 9, further comprising:
judging whether an output power of the engine generator set is equal to a consumed power of the motor by the system control unit, and adjusting the output power of the engine generator set until the output power of the engine generator set is equal to the consumed power of the motor if the output power of the engine generator set is not equal to the consumed power of the motor.
